(19) United States
(12) Patent Application Publication
(10) Pub. No.: US 2024/0151092 A1
(43) Pub. Date: May 9, 2024

(54) VEHICLE HAVING DOOR CLOSURE CONTROL

(71) Applicant: Ford Global Technologies, LLC, Dearborn, MI (US)

(72) Inventors: Brendan Diamond, Grosse Pointe, MI (US); Keith Weston, Canton, MI (US); Stuart C. Salter, White Lake, MI (US); John Robert Van Wiemeersch, Novi, MI (US); Kristopher Karl Brown, Dearborn, MI (US)

(73) Assignee: Ford Global Technologies, LLC, Dearborn, MI (US)

(21) Appl. No.: 17/979,916

(22) Filed: Nov. 3, 2022

(51) Int. Cl. E05F 15/73

(52) U.S. Cl. CPC E05F 15/73; E05F 2015/767; E05Y 2900/531

(57) ABSTRACT

A vehicle includes a cabin interior, a powered door having an actuator for moving the door between closed and open positions, interior sensors sensing position or movement of an occupant in the cabin interior, and exterior sensors sensing a passerby proximate to the vehicle. The vehicle includes a controller determining an occupant intending to exit the vehicle via the door based on the interior sensors and determining a passerby passing by the door in an open position using the at least one exterior sensors. The controller controls the actuator to open the door when the occupant is intended to exit the vehicle and at least partially closes the door when a passerby is detected passing by the vehicle door and an occupant is determined not to be exiting the vehicle. The controller controls the actuator to open the door further when the passerby is determined to pass by the door.

### FIELD OF THE DISCLOSURE

The present disclosure generally relates to the control of vehicle powered doors, and more particularly relates to a system and method of controlling a powered door based on sensed user interaction.

### BACKGROUND OF THE DISCLOSURE

Motor vehicles are commonly equipped with various closure doors to allow ingress and egress of the vehicle passenger compartment. The closure doors may be powered with electric motors which operate to open and close the door. It would be desirable to provide for control of powered doors in a manner that takes into consideration the location of occupants and other persons close to the door.

### SUMMARY OF THE DISCLOSURE

According to a first aspect of the present disclosure, a vehicle having powered door access is provided. The vehicle includes a body defining a cabin interior, a powered door having an actuator for moving the door between closed and open positions, and at least one interior sensor sensing position or movement of one or more occupants in the cabin interior. The vehicle also includes at least one exterior sensor sensing at least one passerby proximate to the vehicle, and a controller determining at least one occupant intending to exit the vehicle via the powered door based on the at least one interior sensor and determining a passerby passing by the powered door in an open position using the at least one exterior sensor, wherein the controller controls the actuator to open the powered door when the at least one occupant is intended to exit the vehicle and at least partially closes the powered door when a passerby is detected passing by the powered door and an occupant is determined not to be exiting the vehicle via the powered door, wherein the controller further controls the actuator to open the powered door further when the passerby is determined have passed by the powered door.

Embodiments of the first aspect of the present disclosure can include any one or a combination of the following features:
the controller prevents movement of the powered door towards the closed position when an occupant is determined to be exiting the vehicle via the powered door;
a controller controls the actuator to prevent movement of the powered door towards the closed position;
the actuator comprises an electric motor;
the actuator comprises a brake device;
the at least one interior sensor comprises at least one of a camera capturing images within the cabin interior;
the at least one interior sensor comprises a seat sensor;
the at least one exterior sensor comprises an exterior imaging device capturing images proximate to the at least one powered door;
the exterior imaging device comprises at least one camera; and
the at least one powered door comprises a passenger door that pivots about a hinge assembly.

According to a second aspect of the present disclosure, a method of controlling a powered door on a vehicle is provided. The method includes sensing position or movement of one or more occupants in a cabin interior of the vehicle, determining at least one occupant intending to exit the vehicle via the powered door based on the at least one interior sensor, controlling an actuator to open the powered door when the at least one occupant is determined to intend to exit the vehicle via the powered door, and sensing a passerby proximate to the vehicle with at least one exterior sensor. The method also includes determining the passerby is passing by the powered door in an open position using the at least one exterior sensor, at least partially closing the powered door when the passerby is detected passing by the powered door and an occupant is determined not to be exiting the vehicle via the powered door, and controlling the actuator to open the door further when the passerby is determined to have passed by the powered door.

Embodiments of the second aspect of the present disclosure can include any one or a combination of the following features:
the step of preventing movement of the powered door towards the closed position when an occupant is determined to be exiting the vehicle via the powered door;
the step of preventing movement of the powered door towards the closed position comprises activating an electric motor to prevent movement of the door towards the closed position;
the step of actuating the door comprises actuating the powered door with an electric motor;
the step of preventing movement of the door towards the closed position comprises braking movement of the door to prevent movement of the door towards the closed position;
the step of sensing position or movement of one or more occupants in the cabin interior comprises sensing the one or more occupants with a camera capturing images within the cabin interior of the vehicle;
the step of sensing position or movement of one or more occupants in the cabin interior comprises sensing an occupant on a seat with a seat sensor;
the step of sensing the passerby comprises sensing the passerby with an exterior imaging device capturing images proximate to the powered door;
the exterior imaging device comprises a camera; and
the actuator pivots the powered door about a hinge assembly.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a top schematic view of a motor vehicle equipped with powered doors and sensors and controls for controlling the doors, according to one embodiment;

FIG. 2 is a block diagram of the motor vehicle having a controller configured to control the powered doors based on sensed conditions;

FIG. 3A is a schematic view of the motor vehicle with one of the doors in the open position and a passerby approaching the vehicle, according to one example;

FIG. 3B is a schematic view of the motor vehicle having one of the powered doors in a retracted position as the passerby passes by the door, according to one example;

FIG. 3C is a schematic view of the motor vehicle with one of the powered doors in the fully open position after the passerby passes by the vehicle, according to a further example; and

FIGS. 4A-4D are a flow diagram illustrating a routine for detecting occupants and other persons approaching the vehicle or exiting the vehicle and controlling the powered doors, according to one example.

### DETAILED DESCRIPTION OF PREFERRED EMBODIMENTS

Reference will now be made in detail to the present preferred embodiments of the disclosure, examples of which are illustrated in the accompanying drawings. Wherever possible, the same reference numerals will be used throughout the drawings to refer to the same or like parts. In the drawings, the depicted structural elements are not to scale and certain components are enlarged relative to the other components for purposes of emphasis and understanding.

As required, detailed embodiments of the present disclosure are disclosed herein; however, it is to be understood that the disclosed embodiments are merely exemplary of the disclosure that may be embodied in various and alternative forms. The figures are not necessarily to a detailed design; some schematics may be exaggerated or minimized to show function overview. Therefore, specific structural and functional details disclosed herein are not to be interpreted as limiting, but merely as a representative basis for teaching one skilled in the art to variously employ the present disclosure.

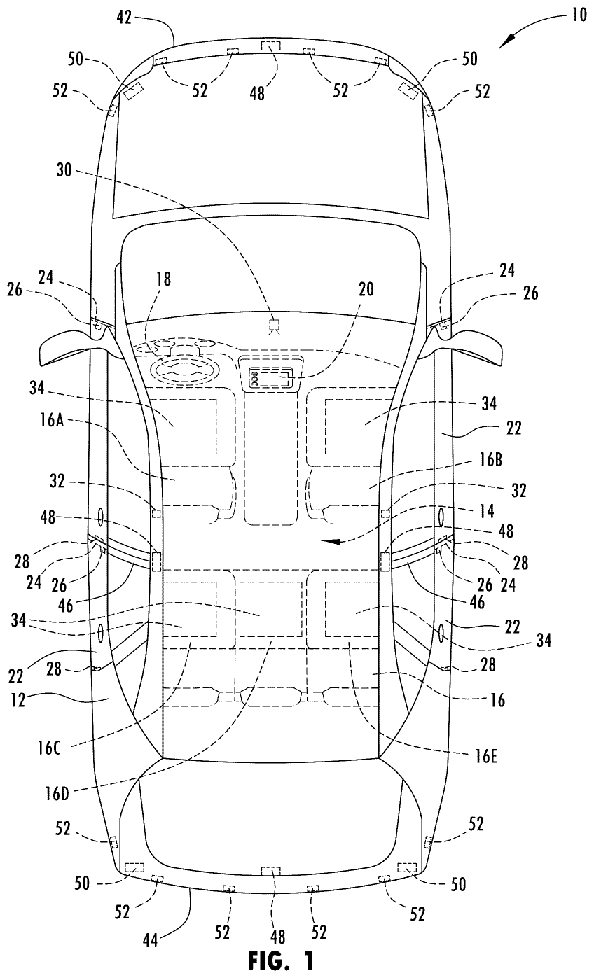

For purposes of description herein, the terms “upper,” “lower,” “right,” “left,” “rear,” “front,” “vertical,” “horizontal,” and derivatives thereof shall relate to the concepts as oriented in FIG. 1. However, it is to be understood that the concepts may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The present illustrated embodiments reside primarily in combinations of method steps and apparatus components related to a vehicle having powered doors and a method of controlling the powered doors. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

As used herein, the term “and/or,” when used in a list of two or more items, means that any one of the listed items can be employed by itself, or any combination of two or more of the listed items, can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

Referring to FIG. 1, a wheeled automotive or motor vehicle 10 is generally illustrated having a cabin interior 14 defined by a vehicle body 12 and configured with passenger seating for transporting passengers in the vehicle 10. The cabin interior 14 is generally defined by the vehicle body 12 and may include various features and trim components within the cabin interior 14. The cabin interior 14 may include an arrangement of passenger seats including a first or front row of driver and passenger seats 16A and 16B generally located towards the front of the cabin interior 14 and one or more rows of passenger seats including a second row of passenger seats 16C-16E located rearward of the front row of passenger seats. The vehicle 10 may be equipped with a steering wheel 18 located in front of the driver seat to enable the driver to steer the vehicle road wheels. Additionally, one or more human machine interfaces (HMI), such as a touchscreen display 20, audio speakers, microphone, etc., may be provided on the vehicle 10 to communicate with the driver and one or more passengers in the vehicle 10.

The vehicle 10 is equipped with powered doors and user detection sensors and controls to assist with operation of the doors of the vehicle 10 and allow the driver and passengers to enter and exit the vehicle 10. The vehicle 10 has a plurality of powered closure doors that include four side passenger doors 22, with two doors on each opposite lateral side of the vehicle 10. Each of the powered doors 22 may close a space such as a space of the cabin interior 14 in the closed door position and allow access to the cabin interior 14 in an open door position. The powered doors 22 are power-operated doors, each having an actuator, such as an electric motor, for moving the corresponding door between the closed and open door positions. The actuators may move the powered doors between the open and closed door positions in response to detecting one or more users approaching the vehicle 10 and attempting to enter the vehicle 10, one or more user occupants attempting to exit the vehicle 10, a passerby passing by the vehicle 10 or a user input command, such as an input entered on a vehicle mounted switch panel, a key fob, a smartphone or other electronic device. The powered doors may be opened and closed by the actuators in response to detecting movement or position of an occupant or potential passenger approaching or departing the vehicle 10. Additionally, the powered doors may be controlled to open partway or close partway to allow a passerby to pass by the vehicle 10 in a travel path that is uninterrupted by the opened door.

It should be appreciated that the vehicle 10 may include additional rows of seating and powered doors, such as may be found on large SUVs, vans and buses. For example, the vehicle 10 may include two side doors or more than four side doors. The vehicle 10 may be a motor vehicle, such as a wheeled car, truck, SUV, van or bus, for example, having one or more powered doors. Each of the powered doors moves relative to the body 12 of the vehicle 10 between a closed door position and an extended open door position and therefore requires door swing space to move between the closed and open door positions. The vehicle controls advantageously assist with operation of the powered doors and/or the vehicle 10 in a manner to reduce the likelihood of interference with an occupant positioned in a door opening or a passerby being interfered with an open door.

The vehicle 10 is shown in FIG. 1 having four side powered doors 22, with two of the side powered doors 22 located forward and adjacent to the front row of seats 16A and 16B and the other two of the side powered doors 22 located rearward thereof and adjacent to the second or rear row of seats 16C and 16E. Each of the side powered doors 22 may include a door panel and window that pivots about hinges 24 generally along a vertical axis to allow the powered door 22 to swing outward through a swing path to an open door position or inward to a flush position with the body 12 of the vehicle 10 where it may be latched via latch 28 in the closed door position. The side doors 22 each includes an actuator such as an electric motor 26 which may be located at or near one of the hinges 24 to power actuate the powered door 22 between the closed and open door positions.

The vehicle 10 is equipped with at least one exterior sensor. In the example shown, the vehicle 10 is equipped with a plurality of exterior sensors that are located and oriented on the vehicle 10 for sensing objects such as potential users, e.g., the driver and one or more passengers expected to enter the vehicle 10 or exit the vehicle 10 and other persons, each referred to as a passerby, passing by the vehicle 10 within a door opening space proximate the vehicle 10. The plurality of exterior sensors generate signals indicative of the sensed objects. The plurality of exterior sensors may include a plurality of exterior imaging devices, such as two exterior side view cameras 48, which are shown located on opposite lateral sides of the vehicle 10 shown at or near the vertical body-mounted pillars 46, an exterior front view camera 48 shown in a front fascia 42 of the vehicle 10 and an exterior rear view camera 48 shown in a rear fascia 44 of the vehicle 10. Each of the exterior cameras 48 may acquire images of the space around the perimeter of the vehicle 10, including covering the swing path of the powered doors within the door opening space and the space proximate thereto. The acquired images may be processed by video processing to identify the objects such as one or more people and the position of the objects relative to the vehicle 10.

The plurality of exterior sensors may also include exterior radar sensors 50 shown located at each of the four corners of the vehicle 10 for sensing objects located outside of the vehicle 10 and within the space surrounding the vehicle 10. The exterior radar sensors 50 transmit radio waves and process their reflections from objects to determine distance to the object and location of the object. Further, the plurality of exterior sensors may include a plurality of exterior ultrasonic sensors 52 shown located at various locations along the exterior front portion and rear portions of the vehicle 10. In the examples shown, six exterior ultrasonic sensors 52 are shown spaced apart and located at or proximate to the rear fascia 44 and six exterior ultrasonic sensors 52 are shown spaced apart and located at or proximate to the front fascia 42. As such, the exterior radar and ultrasonic sensors 50 and 52 may detect the location, size and relative distance from the vehicle 10 to the detected objects. It should be appreciated that other exterior sensors (ex., LiDAR, cameras, etc.) may be employed by the vehicle 10 to sense objects relative to the vehicle 10, including objects within the swing path of the powered doors and proximate thereto, and generate sensed signals that may be used to identify each object and the distance and location of the sensed object relative to the vehicle 10 for use in assisting with the operation of the vehicle 10 and controlling the powered doors 22 of the vehicle 10.

The vehicle 10 is also equipped with a plurality of interior sensors that are located and oriented within the vehicle 10 for sensing objects, such as occupants, including the driver and passengers, located in the vehicle, entering the vehicle 10, and exiting the vehicle 10. The plurality of interior sensors generate signals indicative of the sensed objects. The signals generated by the plurality of interior sensors are then processed by a controller to determine positioning and movement of the occupants within the vehicle 10 such as whether an occupant is intending to exit the vehicle and the door that the occupant intends to exit through, for example.

The plurality of interior sensors may include at least one interior imaging device, such as an interior camera 30, oriented to capture images of the passenger compartment including seats 16A-16E and occupants seated thereon. In the example shown, a single interior camera 30 is shown located near the forward side of the cabin interior 14 capturing images rearward within the vehicle cabin 14. However, it should be appreciated that one or more imaging cameras 30 may be employed at various locations in the vehicle 10 to capture images in the cabin interior 14.

The plurality of interior sensors may also include interior radar sensors 32 shown located on opposite lateral sides of the cabin interior 14 of the vehicle 10 for sensing objects located inside of the cabin interior 14. The interior radar sensors 32 may transmit radio waves and process the reflections from objects and determine distance to the object and location of the object. It should further be appreciated that other time-of-flight sensors, such as ultrasonic sensors 52 or LiDAR sensors (not shown) may be employed as the interior sensors, alone or in combination with other sensors. The interior sensors may be located at various locations within the cabin interior 14 to detect the presence of an object, such as an occupant and movement of the occupant within the cabin interior, such as whether an occupant is intending to exit the vehicle 10 and which door the occupant intends to exit through.

The plurality of interior sensors may further include seat sensors 34 located in each of the seats 16A-16E. Each seat sensor may include a force or weight sensor configured to sense the weight of an occupant to determine whether or not an occupant is seated on a given seat. By monitoring the weight of an occupant on a seat or multiple seats, an occupant may be detected positioned on a given seat or moving from one seat to another, such as moving from an interior seat towards an outer seat proximate an exit door of the vehicle 10 such that it may be determined that an occupant is intending to exit the vehicle 10 through a particular door, for example. The seat sensor 34 may include a seatbelt sensor according to another sensor.

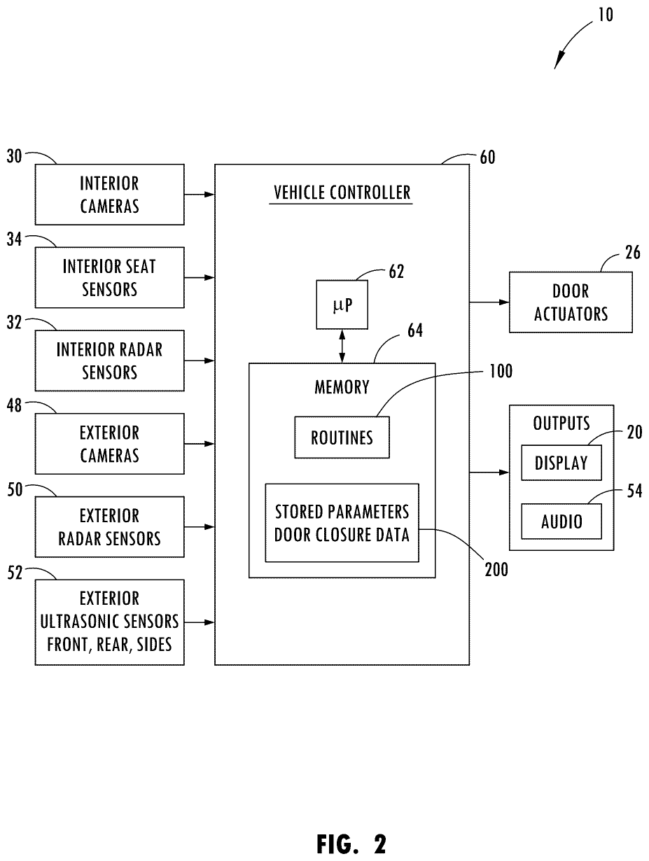

Referring to FIG. 2, the vehicle 10 is further illustrated having a vehicle controller 60 that detects occupants and people that pass by the vehicle (e.g., passerby) and controls one or more powered doors. The vehicle controller 60 in each vehicle may include control circuitry, such as a microprocessor 62 and memory 64. It should be appreciated that the vehicle controller 60 may be comprised of analog and/or digital control circuitry. Stored in memory 64 are one or more routines including a door control routine 100 which may be executed by the microprocessor 62. In addition, various stored parameters and door closure data 200 may be stored in memory 64 and processed by the microprocessor 62. The stored parameters 200 may include powered door data including dimensions for each powered door on the corresponding vehicle, including the distance extended outward from the vehicle body 12 and throughout the door swing path as the door moves between the closed and open door positions. The vehicle controller 60 receives inputs from the plurality of exterior sensors located on the vehicle 10 including the exterior cameras 48, exterior radar sensors 50 and exterior ultrasonic sensors 52 and a plurality of interior sensors located in the vehicle 10 including interior cameras 30, interior radar sensors and interior seat sensors 34. In addition, the vehicle controller 60 generates one or more outputs which may serve as countermeasures and provides the outputs to one or more HMIs such as the touchscreen display 20 and audio speakers 54 located on the vehicle 10 and to the door motors 26. The one or more outputs may serve to activate an actuator (e.g., motor) to open or close a powered door.

The controller 60 provides outputs to each of the electric motors 26 associated with the powered doors 22. As such, the controller 60 may control actuation of the powered doors 22 between the open and closed door positions. In the event that a user such as the driver is approaching the vehicle 10, the driver door may be actuated by the motor 26 to the open position based on a user input or detected intention of the user entering the vehicle 10. In the event that an occupant of the vehicle is determined to be intending to exit the vehicle 10 through one of the powered doors, that the powered door may be actuated by the corresponding motor 36 to the fully open position based on the user's intent to exit the vehicle 10. If the powered door is in an open door position and the occupant still intends to exit the vehicle, the door may be prevented from closing by controlling the motor to prevent closure of the door or by applying a brake to the door in addition to or in lieu of using the motor 26. As such, entrapment of the occupant within the doorway being impinged upon by a closed door may be reduced or prevented.

The controller 60 may determine at least one occupant intending to exit the vehicle 10 via the door based on at least one interior sensor and determining a passerby passing by the door in an open position using at least one exterior sensor. This may occur when the controller 60 controls the actuator to open the door when the at least one occupant is intended to exit the vehicle 10 and at least partially close the door when the passerby is detected passing by the vehicle door and an occupant is determined not to intend to exit the vehicle 10. The controller 60 may further control the actuator to open the door further when the passerby is determined to pass by and become clear of the door. Further, if a passerby e.g., pedestrian, is passing by a door of the vehicle 10, the vehicle door may not open until the passerby has passed by the vehicle door.

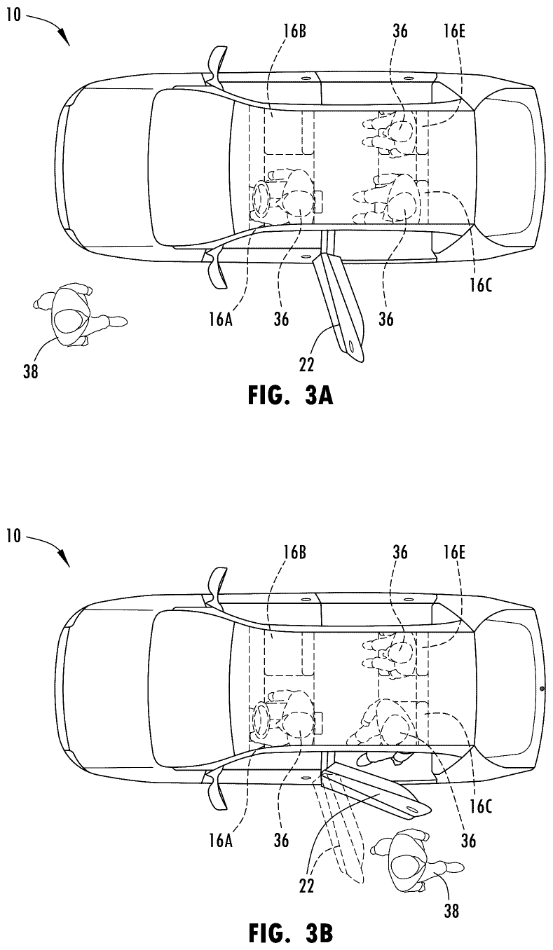

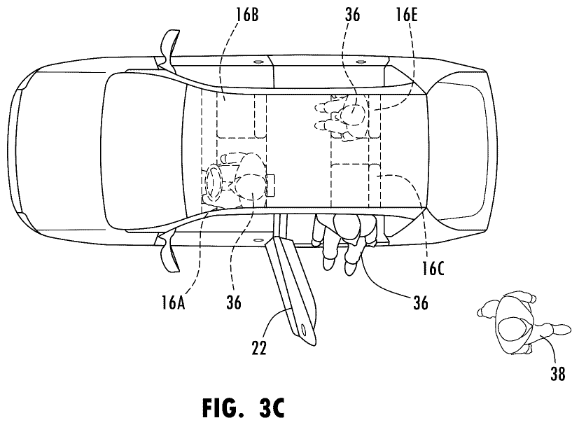

Referring to FIGS. 3A-3C, one example of the vehicle holding seated occupants 36 shown seated in seats 16A, 16C and 16E in the cabin interior 14 is illustrated. In addition, a passerby 38, in the form of a person, is shown approaching the vehicle 10 with a door 22 in the open position. With the door 22 in the open position, one or more of the occupants 36 in the cabin interior 14 may be detected intending to exit the vehicle by processing signals generated by the interior sensors. If an occupant is detected intending to exit the vehicle 10, the door 22 remains in the open position to allow the occupant to exit the vehicle 10. If the occupant is not intending to exit the vehicle 10 with the door 22 in the open position, and the passerby 38 is approaching the door 22 on a path with the swing zone of the door 22, the controller actuates the corresponding actuator to at least partially close the door 22 to allow the passerby 38 to pass by the door 22 unimpeded by the door 22 as seen in FIG. 3B. Once the passerby 38 has passed by the door 22, the door 22 may be actuated back to the fully open door position as seen in FIG. 3C to allow one or more occupants to exit the vehicle 10.

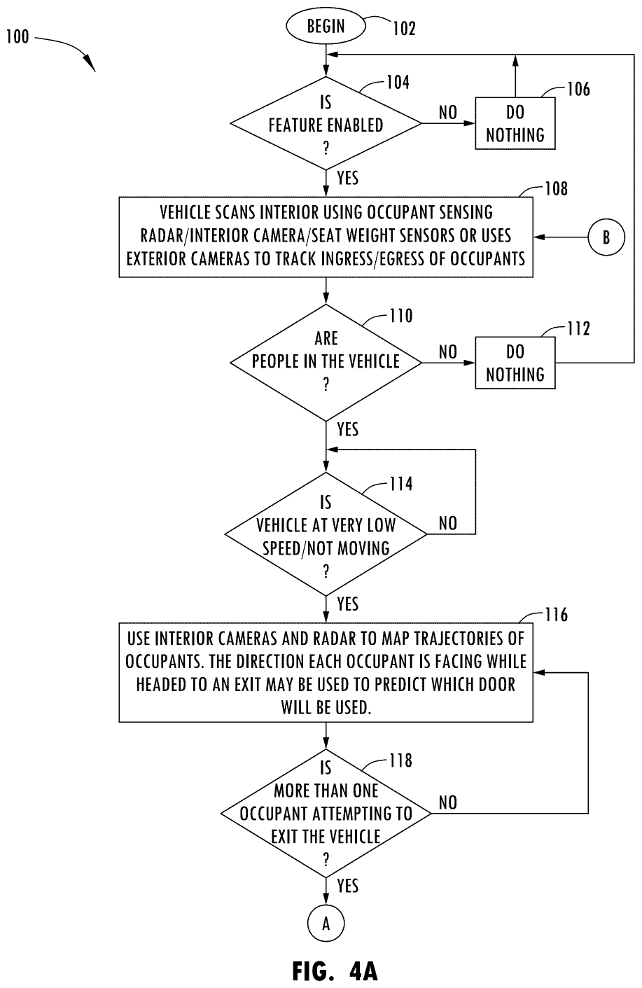

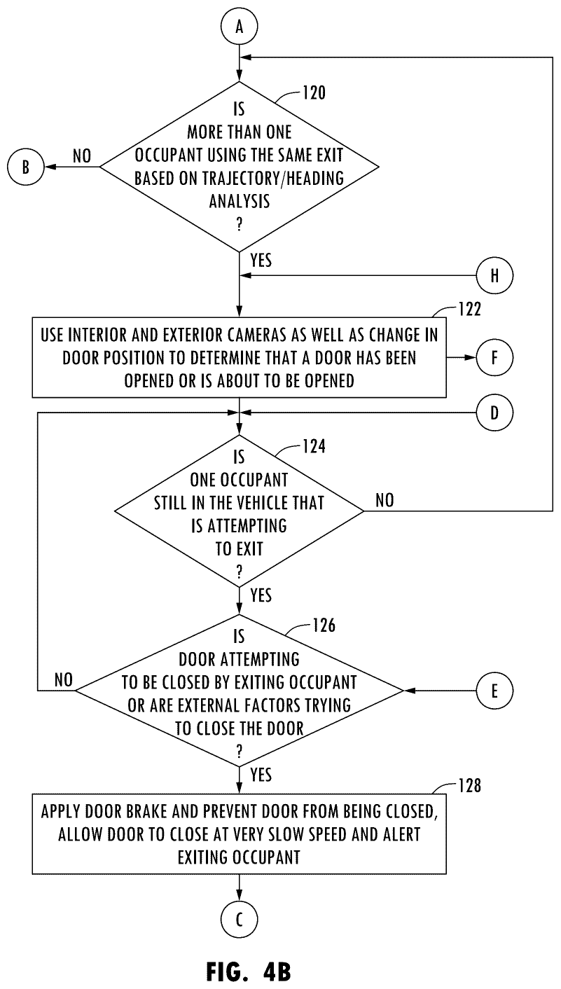

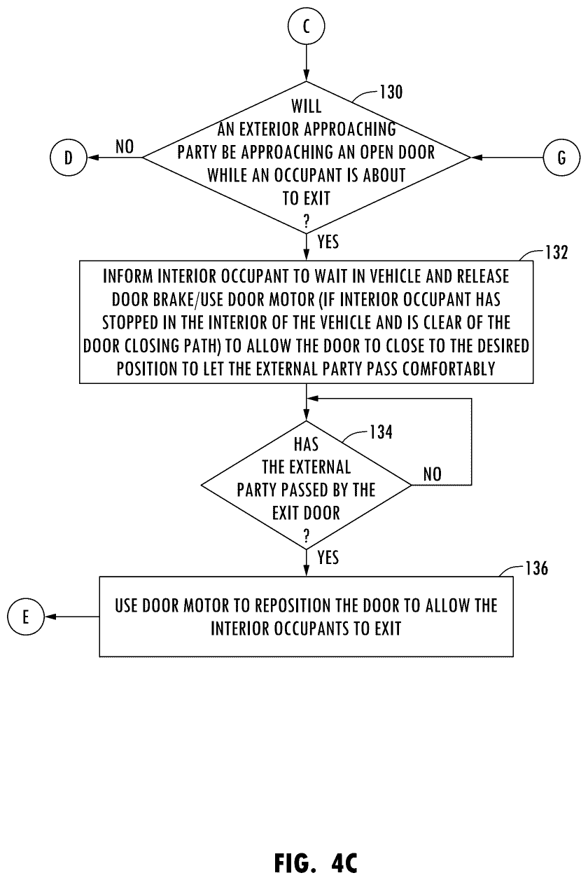

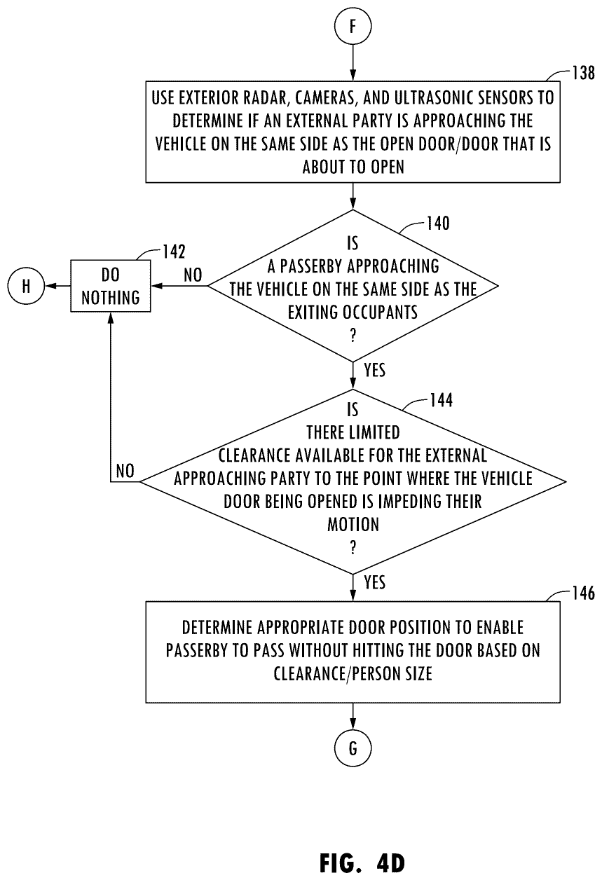

Referring to FIGS. 4A-4D, the door control routine 100 is illustrated for detecting occupants and other persons approaching the vehicle or exiting the vehicle and controlling the powered doors, according to one example. Routine 100 begins at step 102 and proceeds to decision step 104 to determine if the door control feature is enabled and, if not, does nothing at step 106 before returning to step 104. If the door control routine is enabled, the routine 100 proceeds to step 108 where the vehicle scans the cabin interior using the occupant sensing interior sensors such as the radar/interior camera/seat weight sensors or uses the exterior sensors such as the exterior cameras to track ingress/egress of occupants. Next, at decision step 110, routine 100 determines if there are people located in the vehicle and, if not, does nothing at step 112 before returning to step 104. If there are people detected in the vehicle, routine 100 proceeds to decision step 114 to determine if the vehicle is operating at a very low speed such as less than one (1) mph or not moving and, if not, waits until the vehicle is operating at a very low speed or not moving. If the vehicle is operating at a very low speed or not moving, routine 100 proceeds to step 116 to use the interior sensors including the interior cameras and radar to map trajectories of occupants in the vehicle. The direction each occupant is facing while headed to an exit may be used to predict which door an occupant may be intending to exit. The intention of the occupant to exit a particular door may be based on sensing position and movement of the occupant and the position trajectory and heading of the body and face of the occupant as sensed with the interior sensors. Next, at decision step 118, routine 100 determines if more than one occupant is attempting to exit the vehicle and, if not, returns to step 116. If more than one occupant is attempting to exit the vehicle, routine 100 proceeds to decision step 120 to determine if more than one occupant is using the same door to exit the vehicle based on the trajectory/heading analysis of each occupant and, if not, returns to step 108.

If routine 100 determines that more than one occupant is using the same door to exit the vehicle based on the trajectory/heading analysis, routine 100 proceeds to step 122 to use the interior and exterior cameras as well as a change in door position to determine that a door has been opened or is about to be opened. Next, routine 100 simultaneously proceeds to step 138 and to decision step 124. In decision step 124, routine 100 determines if one occupant is still in the vehicle that is attempting to exit the vehicle via a door and, if not, returns to decision step 120. If one occupant is still in the vehicle and attempting to exit, routine 100 proceeds to decision step 126 to determine if the door is attempting to be closed by an exiting occupant or if external factors are trying to close the door, such as wind or a person outside the vehicle, and, if not, returns to decision step 124. If the door is attempting to be closed by an exiting occupant or external factors, routine 100 proceeds to step 128 to apply a door brake such as braking with the motor to prevent the door from being closed, or may allow the door to close at a very slow speed with an alert to the exiting occupant. Thereafter, routine 100 proceeds to decision step 130 to determine whether an exterior approaching party will be approaching an open door while an occupant is about to exit the door of the vehicle and, if not, returns to step 124. If an exterior approaching party, such as a passerby, is determined to be approaching an open door while an occupant is about to exit, routine 100 proceeds to step 132 to inform the interior occupant to wait in the vehicle and release any door brake or braking with the electric motor if the interior occupant has stopped within the interior door and is clear of the door closing path to allow the door to close to the desired position to let the external party pass by comfortably without being impeded by the open door. Thereafter, routine 100 proceeds to decision step 134 to determine if the external passerby party has passed by the exit door and, if so, proceeds to step 136 to use the door motor to reposition the door to allow the interior occupants to exit the vehicle. Otherwise, routine 100 waits for the external party to pass by the door before proceeding. Once the door motor has been repositioned, such as reopened to the fully open door position to allow the interior occupant to exit, routine 100 proceeds to step 126.

Following step 122, routine 100 also proceeds to step 138 to use the exterior radar, LiDAR, cameras, and ultrasonic sensors to determine if an external party, such as a passerby, is approaching the vehicle on the same side as the open door or door that is about to open. Next, at decision step 140, routine 100 determines if a passerby is approaching the vehicle on the same side as the exiting occupant(s) and, if not, does nothing at step 142 before returning to step 122. If a passerby is approaching the vehicle on the same side of the exiting occupant(s), then routine 100 proceeds to decision step 144 to determine if there is limited clearance available for the external approaching party to the point where the vehicle door being opened is impeding their motion and, if not, does nothing at step 142 before returning to step 122. If there is limited clearance available for the external approaching party to the point where the vehicle door being opened is impeding their motion, then routine 100 proceeds to step 146 to determine the appropriate door position to enable the passerby to pass by without hitting the door based on the clearance and size of the person. Thereafter, routine 100 returns to step 130.

Accordingly, the vehicle 10 having the powered door access and method of controlling a powered door of a vehicle advantageously provides for a controlled actuation of one or more vehicle doors based on sensed intended actions of one or more occupants and a passerby passing by the vehicle. The vehicle and method advantageously provides for enhanced control of the powered doors.

It is to be understood that variations and modifications can be made on the aforementioned structure without departing from the concepts of the present disclosure, and further it is to be understood that such concepts are intended to be covered by the following claims unless these claims by their language expressly state otherwise.

What is claimed is:

1. A vehicle having powered door access, the vehicle comprising:
a body defining a cabin interior;
a powered door having an actuator for moving the door between closed and open positions;
at least one interior sensor sensing position or movement of one or more occupants in the cabin interior;
at least one exterior sensor sensing at least one passerby proximate to the vehicle; and
a controller determining at least one occupant intending to exit the vehicle via the powered door based on the at least one interior sensor and determining a passerby passing by the powered door in an open position using the at least one exterior sensor, wherein the controller controls the actuator to open the powered door when the at least one occupant is intended to exit the vehicle and at least partially closes the powered door when a passerby is detected passing by the powered door and an occupant is determined not to be exiting the vehicle via the powered door, wherein the controller further controls the actuator to open the powered door further when the passerby is determined have passed by the powered door.

2. The vehicle of claim 1, wherein the controller prevents movement of the powered door towards the closed position when the occupant is determined to be exiting the vehicle via the powered door.

3. The vehicle of claim 2, wherein a controller controls the actuator to prevent movement of the powered door towards the closed position.

4. The vehicle of claim 3, wherein the actuator comprises an electric motor.

5. The vehicle of claim 3, wherein the actuator comprises a brake device.

6. The vehicle of claim 1, wherein the at least one interior sensor comprises at least one of a camera capturing images within the cabin interior.

7. The vehicle of claim 1, wherein the at least one interior sensor comprises a seat sensor.

8. The vehicle of claim 1, wherein the at least one exterior sensor comprises an exterior imaging device capturing images proximate to the powered door.

9. The vehicle of claim 8, wherein the exterior imaging device comprises at least one camera.

10. The vehicle of claim 1, wherein the powered door comprises a passenger door that pivots about a hinge assembly.

11. A method of controlling a powered door on a vehicle, the method comprising:
sensing position or movement of one or more occupants in a cabin interior of the vehicle;
determining at least one occupant intending to exit the vehicle via the powered door based on the sensed position or movement;
controlling an actuator to open the powered door when the at least one occupant is determined to intend to exit the vehicle via the powered door;
sensing a passerby proximate to the vehicle with at least one exterior sensor;
determining the passerby is passing by the powered door in an open position using the at least one exterior sensor;
at least partially closing the powered door when the passerby is detected passing by the powered door and an occupant is determined not to be exiting the vehicle via the powered door; and
controlling the actuator to open the powered door further when the passerby is determined to have passed by the powered door.

12. The method of claim 11 further comprising the step of preventing movement of the powered door towards a closed position when the occupant is determined to be exiting the vehicle via the powered door.

13. The method of claim 12, wherein the step of preventing movement of the powered door towards the closed position comprises activating an electric motor to prevent movement of the door towards the closed position.

14. The method of claim 13, wherein the step of preventing movement of the door towards the closed position comprises braking movement of the door to prevent movement of the door towards the closed position.

15. The method of claim 11, wherein the step of controlling the actuator comprises controlling an electric motor.

16. The method of claim 11, wherein the step of sensing position or movement of one or more occupants in the cabin interior comprises sensing the one or more occupants with a camera capturing images within the cabin interior of the vehicle.

17. The method of claim 11, wherein the step of sensing position or movement of one or more occupants in the cabin interior comprises sensing an occupant on a seat with a seat sensor.

18. The method of claim 11, wherein the step of sensing the passerby comprises sensing the passerby with an exterior imaging device capturing images proximate to the powered door.

19. The method of claim 18, wherein the exterior imaging device comprises a camera.

20. The method of claim 11, wherein the actuator pivots the powered door about a hinge assembly.
